(19) United States
(12) Patent Application Publication
(10) Pub. No.: US 2024/0399717 A1
(43) Pub. Date: Dec. 5, 2024

(54) VEHICLE INTERIOR COMPONENT HAVING COATED FRAME FOR ADHESIVE BONDING WITHOUT PRIMER

(71) Applicant: CORNING INCORPORATED, CORNING, NY (US)

(72) Inventors: Carl Samuel Brown, Cayuta, NY (US); Ray Gage Gibson, III, Bath, NY (US); Kristi Lynn Simonton, Erin, NY (US); Arlin Lee Weikel, Mansfield, PA (US)

(21) Appl. No.: 18/700,570

(22) PCT Filed: Sep. 27, 2022
(86) PCT No.: PCT/US2022/044839

§ 371 Date: Apr. 11, 2024

Related U.S. Application Data
(60) Provisional application No. 63/256,669, filed on Oct. 18, 2021.

(51) Int. Cl. B32B 17/06; B32B 1/00; B32B 3/08; B32B 7/12; B32B 15/18; B32B 15/20; B60R 13/02; C03C 27/04; C09D 5/44

(52) U.S. Cl. CPC B32B 17/061; B32B 1/00; B32B 3/08; B32B 7/12; B32B 15/18; B32B 15/20; B60R 13/02; C03C 27/048; C09D 5/4411; C09D 5/443; B32B 2255/06; B32B 2255/26; B32B 2255/28; B32B 2307/4023; B32B 2307/54; B32B 2307/542; B32B 2605/003

(57) ABSTRACT

Disclosed are embodiments of a vehicle interior component. The vehicle interior component includes a glass article having a first major surface and a second major surface in which the second major surface is opposite to the first major surface. The vehicle interior component also includes a frame comprising a support surface and a coating disposed on the support surface of the frame. The vehicle interior component further includes an adhesive joining the second major surface of the glass article to support surface of the frame. The adhesive is bonded directly to the coating.

### PRIORITY

This application claims the benefit of U.S. Application No. 63/256,669 filed Oct. 18, 2021, which is incorporated by reference herein in its entirety.

### BACKGROUND

The disclosure relates to a vehicle interior component and, more particularly, to a vehicle interior component have a coated frame for adhesive bonding without the use of a chemical primer.

Vehicle interiors include curved surfaces and can incorporate displays in such curved surfaces. The materials used to form such curved surfaces are typically limited to polymers, which do not exhibit the durability and optical performance as glass. As such, curved glass substrates are desirable, especially when used as covers for displays. Existing methods of forming such curved glass substrates, such adhering a glass substrate to a frame, have drawbacks because the glass substrate needs to be prepared with a chemical primer. Chemical primers can be subject to various environmental regulations that restrict where such chemical primers can be used, potentially creating a disruption in a manufacturing process and increasing the cost to manufacture a vehicle interior component.

### SUMMARY

Accordingly, a need exists for vehicle interior systems that can incorporate a curved glass substrate in a cost-effective manner and without problems typically associated with conventional forming processes that utilize chemical primers.

According to an aspect, embodiments of the disclosure relate to a vehicle interior component. In one or more embodiments, the vehicle interior component includes a glass article having a first major surface and a second major surface in which the second major surface is opposite to the first major surface. In one or more embodiments, the vehicle interior component also includes a frame comprising a support surface and a coating disposed on the support surface of the frame. In one or more embodiments, the vehicle interior component further includes an adhesive joining the second major surface of the glass article to support surface of the frame. In one or more embodiments, the adhesive is bonded directly to the coating.

According to another aspect, embodiments of the disclosure relate to a method of preparing a vehicle interior component. In one or more embodiments of the method, an adhesive is applied between a glass article and a frame, and the glass article is joined to the frame. In one or more embodiments, the glass article includes a first major surface and a second major surface in which the second major surface is opposite to the first major surface. In one or more embodiments, the frame includes a support surface having a coating disposed thereon, and the adhesive is bonded directly to the coating.

According to still another aspect, embodiments of the disclosure relate to a frame for a vehicle interior component. In one or more embodiments, the frame includes a support surface defining a curvature and at least one aperture configured to surround a display unit. In one or more embodiments, the frame also includes a paint coating applied to the support surface. In one or more embodiments, the curvature has a radius of 30 mm to 5000 mm, and the paint coating includes a polyurethane, an acrylic, or an epoxy.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments.

FIG. 1 is a perspective view of a vehicle interior with vehicle interior systems, according to exemplary embodiments.

FIG. 2 depicts a V-shaped vehicle interior component, according to an exemplary embodiment.

FIG. 3 depicts a detail view of a portion of the V-shaped interior component of FIG. 2, according to an exemplary embodiment.

FIG. 4 depicts an exploded perspective view of a vehicle interior component positioned over a forming surface, according to an exemplary embodiment.

FIG. 5 depicts a C-shaped vehicle interior component, according to an exemplary embodiment.

FIG. 6 depicts a cross-section of a vehicle interior component with display units, according to an exemplary embodiment.

FIG. 7 depicts geometric dimensions of a glass substrate of a glass article, according to an exemplary embodiment.

FIG. 8 depicts a flow diagram of a method of forming a vehicle interior component, according to an exemplary embodiment.

### DETAILED DESCRIPTION

Reference will now be made in detail to various embodiments, examples of which are illustrated in the accompanying drawings. In general, the present disclosure is directed to vehicle interior components having a frame attached to a glass article without the use of a chemical primer to promote adhesion. As will be described hereinbelow, the use of chemical primers on the frame can be avoided by applying a coating to the frame. According to exemplary embodiments, the coating is an electrodeposition coating (or “e-coating”), or the coating is a paint that is sprayed, brushed, or rolled onto the frame. Such coatings provide the requisite surface chemistry and/or surface free energy to create a strong bond with the adhesive layer. Conventionally, chemical primers were needed to create a bond with the adhesive having sufficient strength. However, industrial chemical primers are often subject to environmental regulations that restrict geographic locations where such primers can be used, potentially leading to the division of manufacturing steps across multiple facilities. Because the primer is only effective for a short period of time after being applied to the frame, application of the primer to the frame typically must take place where the vehicle interior component is assembled. In contrast, the frame coatings can be applied in facilities specifically designed to apply such coatings, and the coatings have a much longer shelf-life, allowing for shipping and storage without losing effectiveness. These and other aspects and advantages will be described in relation to the embodiments provided below and in the drawings. These embodiments are presented by way of example and not by way of limitation.

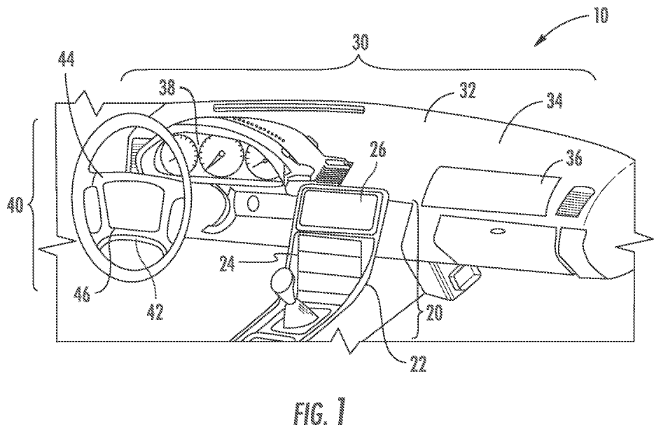

FIG. 1 shows an exemplary interior 10 of a vehicle that includes three different embodiments of vehicle interior systems 20, 30, 40. Vehicle interior system 20 includes a base, shown as center console base 22, with a surface 24 including a display 26. Vehicle interior system 30 includes a base, shown as dashboard base 32, with a surface 34 including a display 36. The dashboard base 32 typically includes an instrument panel 38 which may also include a display. Vehicle interior system 40 includes a base, shown as steering wheel base 42, with a surface 44 and a display 46. In one or more embodiments, the vehicle interior system includes a base that is an arm rest, a pillar, a seat back, a floor board, a headrest, a door panel, or any portion of the interior of a vehicle that includes a curved surface. In one or more embodiments, at least one of the surfaces 24, 34, 44 is curved. In one or more embodiments, at least one of the surfaces 24, 34, 44 is flat or planar.

The embodiments of the vehicle interior components described herein can be used as displays 26, 36, 38, 46 in each of vehicle interior systems 20, 30, 40, amongst others. In such embodiments, the vehicle interior component discussed herein may include a cover glass substrate that also covers non-display surfaces of the dashboard, center console, steering wheel, door panel, etc. In such embodiments, the glass material may be selected based on its weight, aesthetic appearance, etc. and may be provided with a surface treatment (e.g., an ink or pigment coating) including a pattern (e.g., a brushed metal appearance, a wood grain appearance, a leather appearance, a colored appearance, etc.) to visually match the glass components with adjacent non-glass components. In specific embodiments, such ink or pigment coating may have a transparency level that provides for deadfront or color matching functionality when the display 26, 36, 38, 46 is inactive. Further, while the vehicle interior of FIG. 1 depicts a vehicle in the form of an automobile (e.g., cars, trucks, buses and the like), the vehicle interior components disclosed herein can be incorporated into other vehicles, such as trains, sea craft (boats, ships, submarines, and the like), aircraft (e.g., drones, airplanes, jets, helicopters and the like), and spacecraft.

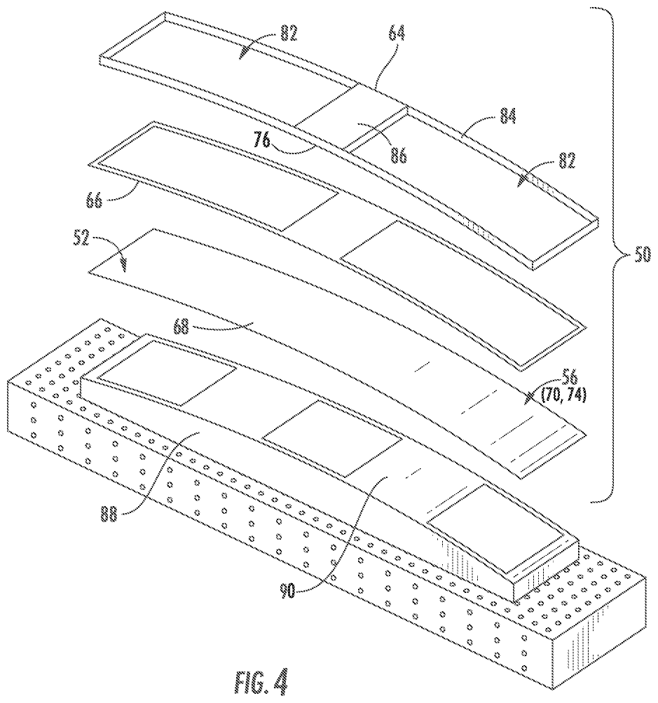

In embodiments, the surfaces 24, 34, 44 can be any of a variety of curved shapes, such as V-shaped or C-shaped as shown in FIGS. 2 and 4, respectively. Referring first to FIG. 2, a side view of an embodiment of a V-shaped vehicle interior component 50 is shown. The vehicle interior component 50 includes a glass article 52 having a first major surface 54, a second major surface 56 opposite to the first major surface 54, and a minor surface 58 joining the first major surface 54 to the second major surface 56. The first major surface 54 and the second major surface 56 define a thickness T of the glass article 52. In embodiments, the thickness T of the glass article 52 is from 0.3 mm to 2 mm, in particular 0.5 mm to 1.1 mm. In a vehicle, the first major surface 54 faces the occupants of the vehicle.

In embodiments, the first major surface 54 and/or the second major surface 56 may comprise a glass surface. In other embodiments, the first major surface 54 and/or the second major surface 56 may comprise one or more surface treatments. Examples of surface treatments that may be applied to one or both of the first major surface 54 and second major surface 56 include at least one of an anti-glare coating, an anti-reflective coating, a coating providing touch functionality, a decorative (e.g., ink or pigment) coating, or an easy-to-clean coating. In embodiments, the one or more surface treatments comprise the entire first major surface 54 and/or second major surface 56, respectively. In other embodiments, the one or more surface treatments comprise less than the entire first major surface 54 and/or second major surface 56, respectively. For example, the surface treatment may be present only as a border around the glass article 52, or in another example, the surface treatment may be present only where a display unit is to be mounted.

As can be seen in FIG. 2, the V-shaped glass article 52 has a curved region 60 disposed between a first flat section 62a and a second flat section 62b. Further, as shown in FIG. 2, the curved region 60 defines a concave curve with respect to the first major surface 54, but in other embodiments, the curved region 60 is instead a convex curve with respect to the first major surface 54. The curved region 60 is defined by a radius of curvature R. In embodiments, the radius of curvature R can be as low as 20 mm or up to 10,000 mm, in particular as low as 20 mm or up to 5,000 mm, and most particularly as low as 20 mm or up to 2,500 mm.

In the vehicle interior component 50 of FIG. 2, a frame 64 is attached to the second major surface 56 of the glass article 52. In one or more embodiments, the frame 64 is a metal (e.g., aluminum, magnesium, or steel alloy), plastic, or composite (e.g., fiber-filled resin) material. The frame 64 is attached to the glass article 52 via an adhesive layer 66. In embodiments, the adhesive layer 66 joining the frame 64 to the glass article 52 is a structural adhesive, such as at least one of a toughened epoxy, a flexible epoxy, an acrylic, a silicone, a urethane, a polyurethane, or a silane modified polymer. In embodiments, the adhesive layer 66 has a thickness of 2 mm or less between the frame 64 and the glass article 52. In one or more embodiments, the frame 64 may be further attached to the glass article 52 via mechanical fasteners, such as clips (not shown) holding the glass article 52 to the frame 64.

As disclosed in one or more embodiments herein, no chemical primer is applied to the frame 64 or to the second major surface 56 to prepare the glass article 52 for bonding to the adhesive layer 66. As used herein, “chemical primer” is used to refer to a dilute solution of a primer in an organic solvent. In general, chemical primers are used to wet a surface to which the adhesive layer is applied, penetrate the surface to create a strong bond with the surface, and/or intermix or chemically react with the adhesive layer to create a strong bond with the adhesive layer. In certain conventional vehicle interior components, proper bonding of the adhesive layer required that a chemical primer be applied to the frame and to the second major surface of the glass article before application of the adhesive layer. Often the chemical primer cures by evaporation of the solvent, releasing volatile organic compounds into environment, and various environmental regulations restrict the release of such compounds in certain localities, which can limit where the chemical primer can be applied and where the vehicle interior component can be assembled. Further, environmental regulations may require specialized equipment for application of the chemical primer and for its disposal.

These requirements associated with the use of a chemical primer increase the cost of the manufacturing process and can potentially require the manufacturing process to be split between multiple locations. However, regarding the latter point, cured chemical primers have relatively short shelf-lives, which means that they cannot be adequately stockpiled or shipped in large quantities for assembly. Thus, the chemical primers are generally applied on-site where the component is assembled. Accordingly, elimination of primer in the manufacturing process is expected to decrease manufacturing cost and improve manufacturing efficiency by avoiding costly environmental compliance and by allowing manufacturing to take place in a single facility, in particular on a single processing line.

According to one or more embodiments of the present disclosure, the use of a chemical primer in the manufacturing process is eliminated at least in part by applying a coating to the frame 64 prior to joining the frame 64 to the glass article 52 with the adhesive layer 66. As will be discussed more fully below, in one or more embodiments, the coating is an electrodeposition coating, or “e-coating.” In one or more embodiments, the coating is a paint.

In one or more embodiments, the coating has a thickness of about 10 μm to about 50 μm, in particular about 15 μm to about 40 μm, and particularly about 20 μm. A coating in this thickness range is thick enough to provide an effective surface to which the adhesive layer 66 bonds and to provide sufficient color and oxidative and hydrolytic stability. Further, a thickness in the described range is thin enough to avoid formation of internal defects, such as bubbles that may develop during curing. Additionally, with respect to the e-coating, the thickness of the coating may be limited by the insulative nature of the coating, i.e., the electrodeposition process is slowed or stopped for a given application voltage as the coating thickness increases because the coating insulates the metal of the frame 64.

In one or more embodiments, the coating (either e-coating or paint) is characterized as a binder film carrying a colorant (e.g., dye or pigment) applied to at least a portion of the frame 64. Advantageously, in one or more embodiments, the coatings eliminate the use of the solvents associated with chemical primers from the process, avoiding the environmental restrictions placed on chemical primers. Further, in one or more embodiments, the coatings are sufficiently durable and maintain sufficient surface activity for bonding to the adhesive layer 66 such that, even if application of the coatings requires the use of solvents, they can be prepared at another site specially designed for handling such solvents and shipped to and stored at the location of assembly without causing disruptions in the manufacturing process.

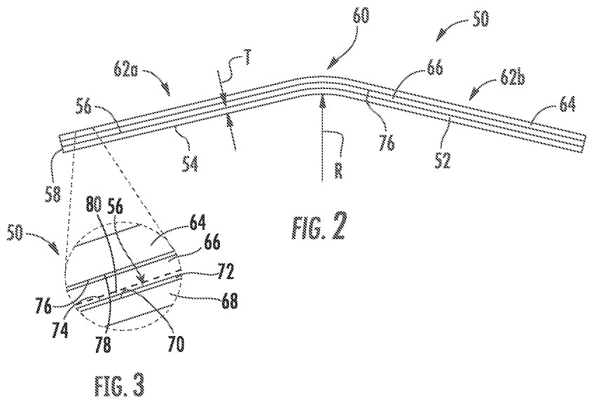

FIG. 3 is a detail schematic depiction of a portion of the vehicle interior component 50. In embodiments, the glass article 52 includes at least a glass substrate 68. In embodiments, the glass article 52 only includes the glass substrate 68 and the second major surface 56 is a glass surface 70. In embodiments, the glass article 52 also includes a colorant layer 72 disposed over the glass substrate 68. The colorant layer 72 includes dyes or pigments that impart a decorative and/or functional aspect to the glass article 52. In one or more embodiments, the colorant layer 72 provides a black matrix border along the periphery of the glass article. For example, and as mentioned above, a colorant layer 72 may be provided on the glass article to provide a deadfront feature that blends the glass substrate 68 (i.e., cover glass) into the surrounding surface. Such colorant layer 72 may, for example, resemble wood grain, leather, carbon fiber, or brushed metal. When a display is activated, the brightness of the display shows through the colorant layer 72 to be visible through the glass substrate 68. In other embodiments, the colorant layer 72 may be a solid color, such as a solid color border or a color matching surface, to hide the display or its surrounding electrical connections. In embodiments of the glass article 52 including a colorant layer 72, the second major surface 56 is a colorant surface 74. In embodiments, the colorant layer 72 is an ink layer. In embodiments, the colorant layer 72 comprises a thickness of 1 μm to 20 μm, in particular about 7 μm to 9 μm.

Further, as shown in FIG. 3, the frame 64 includes a support surface 76. The support surface 76 faces the second major surface 56 of the glass article 52, and a coating 78 is applied to the support surface 76 of the frame 64 to facilitate primer-less bonding of the adhesive layer 66 to the frame 64. In this way, the adhesive layer 66 is directly bonded to the coating 78 of the frame 64. By “bonded directly” or “directly bonded,” it is meant that there is no intervening layer or coating between the adhesive material of the adhesive layer 66 and the coating 78 of the frame 64. As mentioned above, the coating 78 may be an e-coating or a paint.

As used herein, “e-coating” refers to a method of painting that uses electrical current to deposit paint on a surface. As mentioned above, e-coating is also known as a shorthand for electrodeposition coating, which is also known as electrolytic coating, electrophoretic coating, electropainting, or electrocoating. An e-coating can be applied to a metal frame or, e.g., a plastic or composite frame with a metallized surface.

In embodiments where the coating 78 is an e-coating, the coating 78 may be applied to the exterior metal surface, including at least the support surface 76, of the frame 64 using the following exemplary process. It should be understood that alternative e-coating processes, including different orders and number of steps, are contemplated and within the scope of the present disclosure. As an initial step of an exemplary e-coating process, the exterior metal surface of the frame 64 is cleaned, e.g., using an alkaline cleaning, to remove any dirt or grime that might prevent the paint from sticking. Thereafter, the exterior metal surface is deoxidized to remove any oxide coating that may be present on the surface of the frame 64. The exterior metal surface may then be pretreated, typically with a zinc-phosphate bath. Thereafter, the exterior metal surface is rinsed, and the frame 64 is then dipped into an electrocoating tank for application of the paint material to the exterior metal surface. During the electrocoating dip, the exterior metal surface may be either positively or negatively charged, which attracts the negatively or positively charged paint material suspended in the bath, respectively. If the metal surface is positively charged and the paint material is negatively charged, then the e-coating process is an anodic process. If the metal surface is negatively charged and the paint material is positively charged, then the e-coating process is a cathodic process. In one or more embodiments, the paint applied to the exterior metal surface of the frame 64 is an epoxy or an acrylic. After application of the e-coating, the frame 64 is rinsed and baked to cure the e-coating. In one or more embodiments, the e-coating is applied to only a portion of the exterior metal surface of the frame 64, such as only the support surface 76, but in one or more other embodiments, the e-coating is applied to the entire exterior metal surface of the frame 64.

The coating 78 may also include a paint that is applied to the exterior surface, including at least the support surface 76, of the frame 64 in a manner other than e-coating. In embodiments, the paint of the coating 78 is applied onto the support surface 76, for example, by spraying, brushing, or rolling. In embodiments, the paint may also be applied to the colorant surface 74 of the glass article 52, using similar techniques, as described herein.

Further, because of the different application method, the paint may be based on a different chemistry. In one or more embodiments, the paint is a polyurethane paint, an acrylic paint, or an epoxy paint. In one or more embodiments, the paint coating may be applied over a paint primer. A paint primer is distinct from a chemical primer for an adhesive, which are avoided in the present disclosure, because a paint primer does not utilize the same solvents that present environmental regulatory concerns as a chemical primer. In one or more embodiments, the paint primer is a pretreatment for the paint to provide a prepared surface to which the paint is able to bond.

Advantageously, both the e-coating and the paint can be applied upstream of the manufacturing process for assembling the vehicle interior component 50. In particular, the painted or e-coated frame 64 can be prepared at a facility specializing in the painting or e-coating process, and the frames 64 so prepared can be easily shipped and stored for long periods of time. In contrast, the use of chemical primers generally has to be incorporated into the process for assembling the vehicle interior component because the primed surface has a shelf-life of only a few days, making shipping and storage of primed parts impractical. Accordingly, the frame and glass article are typically primed in the same facility in which they are assembled, meaning that the facility has to comply with relevant environmental regulations associated with the use of such primers.

The elimination of primer for bonding of the adhesive layer 66 to the frame 64 has been described, but the primer used to bond the adhesive layer 66 to the glass article 52 can also be eliminated via plasma treatments or application of a paint to the second major surface 56. For example, in one or more embodiments, the adhesive layer 66 is bonded directly to the glass article 52 by plasma-treating the second major surface 56 of the glass article 52. By “bonded directly” or “directly bonded,” it is meant that there is no intervening layer or coating between the adhesive material of the adhesive layer 66 and the second major surface 56 of the glass article 52. The plasma-treating can be applied to the second major surface 56 in the form of the glass surface 70 or the colorant surface 74. In one or more embodiments, the plasma-treating provides a desirable level of surface free energy (i.e., 35 mN/m or more) on the second major surface 56 to allow for bonding to the adhesive layer 66 without use of a primer. In one or more embodiments, the surface free energy of the second major surface 56 is in a range from about 35 mN/m to about 80 mN/m, from about 40 mN/m to about 75 mN/m, from about 45 mN/m to about 70 mN/m, from about 50 mN/m to about 60 mN/m, or any ranges or subranges therebetween. In one or more embodiments, the plasma treatment is an atmospheric plasma treatment.

During plasma treatment, the second major surface 56 is contacted with plasma, which is a reactive mixture of gas species containing large concentrations of ions, electrons, free radicals, and other neutral species. The plasma may be used to remove contaminants from the second major surface 56 and activate the second major surface 56 by providing reactive functional groups on the second major surface 56. Advantageously, plasma treatment does not create hazardous by-products and is itself environmentally-friendly. Thus, plasma treatments can substantially reduce or completely avoid the environmental concerns associated with conventional chemical primer treatments.

In particular embodiments, the plasma treatment is an atmospheric plasma treatment. In embodiments, the plasma is radio-frequency capacitive discharge plasma. In embodiments, the plasma treatment is conducted using argon and oxygen as the working gases. In embodiments, the oxygen to argon ratio is 0.1% to 5%. In embodiments, the power setting for the plasma treatment is 10 Watts to 2000 Watts, in particular 150 Watts to 200 Watts. In embodiments, the plasma is applied to the second major surface 56 using a nozzle, in particular a nozzle attached to an automated robot arm. In such embodiments, the working distance of the nozzle from the second major surface 56 is from about 2 mm to about 10 mm. In one or more embodiments in which a nozzle is used to apply the plasma, the nozzle is scanned over the second major surface 56 at a speed of at least 10 mm/s. In embodiments, the speed is up to 90 mm/s, and in still other embodiments, the speed is greater than 90 mm/s.

Alternatively or in addition to plasma-treating the second major surface 56, the second major surface 56 may be prepared via application of a paint layer 80 thereto. In such embodiments, the paint layer 80 may be applied over the colorant layer 72. In other embodiments, the paint layer 80 may be applied directly to the glass surface 70 of the glass substrate 68 in place of the colorant layer 72. In such embodiments, the adhesive layer 66 may be directly bonded to the paint layer 80. By “bonded directly” or “directly bonded,” it is meant that there is no intervening layer or coating between the adhesive material of the adhesive layer 66 and the paint layer 80.

Having described the structure of the vehicle interior component 50, the discussion will turn now to the assembly of the vehicle interior component 50. In one or more embodiments, the adhesive layer 66 is disposed on the second major surface 56 of the glass article, and the frame 64 is moved into contact with the adhesive layer 66 so that the adhesive layer 66, after any necessary curing, bonds the frame 64 to the glass article 52. In other embodiments, the adhesive layer 66 may instead be applied to the frame 64, and the frame 64 may be moved so that the adhesive layer 64 contacts the second major surface 56.

In the embodiment shown in FIG. 4, the frame 64 is not bonded to the entirety of the second major surface 56. Instead, the frame 64 includes apertures 82 designed to accommodate display units. Thus, in the embodiment depicted, the frame 64 defines a border 84 and a central pillar 86. The adhesive layer 66 is applied in substantially the same shape as the frame 64, and as such, the region of the glass article 52 that is plasma-treated or painted may be limited to regions where the adhesive layer 66 is provided to attach the frame 64 to the glass article 52. Adhesive may be applied to the glass article 52 and/or frame 64 in a pattern that varies depending on the implementation (e.g., depending on the shape of the frame 64, the shape of the glass article 52, the curvature of the glass article 52). In embodiments, the adhesive layer 66 is applied to the glass article 52 and/or frame 64 in a non-uniform pattern such that some portions of the interface between the glass article 52 and frame 64 do not have an adhesive disposed therebetween.

In embodiments, the vehicle interior components 50 according to the present disclosure are formed by cold-forming techniques. In general, the process of cold-forming involves application of a bending force to the glass article 52 while the glass article 52 is situated on a forming structure 88 as shown in the exploded view of FIG. 4. As can be seen, the forming structure 88 has a curved forming surface 90, and the glass article 52 is bent into conformity with the curved forming surface 90. In embodiments, the glass article 52 is held into conformity with the curved forming surface 90 of the forming structure 88 using vacuum pressure (e.g., pulled through the forming structure 88) and/or mechanical restraints, such as clips or clamps.

Advantageously, it is easier to apply surface treatments and colorant layers 72 to a flat glass substrate 68 prior to creating the curvature in the glass substrate 68, and cold-forming allows the treated glass substrate 68 to be bent without destroying the surface treatment and/or colorant layers 72 (as compared to the tendency of high temperatures associated with hot-forming techniques to destroy surface treatments, which requires surface treatments and colorant layers to be applied to the curved article in a more complicated process). In embodiments, the cold-forming process is performed at a temperature less than the softening temperature of the glass composition of the glass substrate 68. In particular, the cold forming process may be performed at room temperature (e.g., about 23° C.) or a slightly elevated temperature, e.g., at 200° C. or less, 150° C. or less, 100° C. or less, or at 50° C. or less, which may assist with curing of the adhesive layer 66. Further, in embodiments, the cold-forming process may involve an accelerated cure using, e.g., infrared or ultraviolet radiation.

For such curved, cold-formed vehicle interior components 50, the frame 64 holds the glass article 52 in the curved shape (at least in the curved region 60) via the bond created by the adhesive layer 66. In particular, the curvature created in the cold-formed glass article 52 is not permanent. That is, the glass article 52 would spring back to a planar, non-curved (i.e., flat) configuration if the glass article 52 was not attached to the frame 64. Thus, the glass article 52 is stressed to produce the curvature and remains stressed during the life of the vehicle interior component 50. Besides holding the glass article 52 in the cold-formed configuration, the frame 64 facilitates mounting the vehicle interior component 50 to a vehicle interior base (such as center console base 22, dashboard base 32, and/or steering wheel base 42 as shown in FIG. 1).

FIG. 8 depicts an example method 100 for assembling a vehicle interior component 50 having a frame 64 with a coating 78. The method 100 includes a first step 110 of applying the adhesive layer 66 to at least one of the glass article 52 and the frame 64 having the coating 78 disposed thereon. In a second step 120, the glass article 52 is joined to the frame 64 via the adhesive layer 66 such that the adhesive layer 66 is directly bonded to the coating 78 of the frame 64. After the adhesive layer 66 cures, the glass article 52 will be attached to the frame 64 and ready for installation in a vehicle. In embodiments of the method 100, the glass article 52 may be joined to the frame 64 is a cold-forming process as described above. Further, the a display unit may be attached to the glass article before, during, or after the joining of the glass article 52 to the frame 64.

FIG. 5 depicts another embodiment of a vehicle interior component 50, in particular a C-shaped vehicle interior component 50. As compared to the V-shaped vehicle interior component 50 of FIG. 2, the C-shaped vehicle interior component 50 of FIG. 5 has a larger curved region 60 and shorter flat sections 62a, 62b. The V-shape and C-shape are but two examples of curved vehicle interior components 50. In other embodiments, the vehicle interior components 50 can include curved regions 60 having opposing curvatures to create an S-shape, a curved region 60 followed by a flat section 62a to create a J-shape, and curved regions 60 separated by a flat section 62a to create a U-shape, among others. Further, while the curved regions 60 and flat sections 62a, 62b are depicted as being symmetrical, the curved regions 60 and flat sections 62a, 62b are asymmetrical in other embodiments. For example, one flat section 62a may be longer than the other flat section 62b, or the curvature of a curved region 60 may extend further in one direction than another.

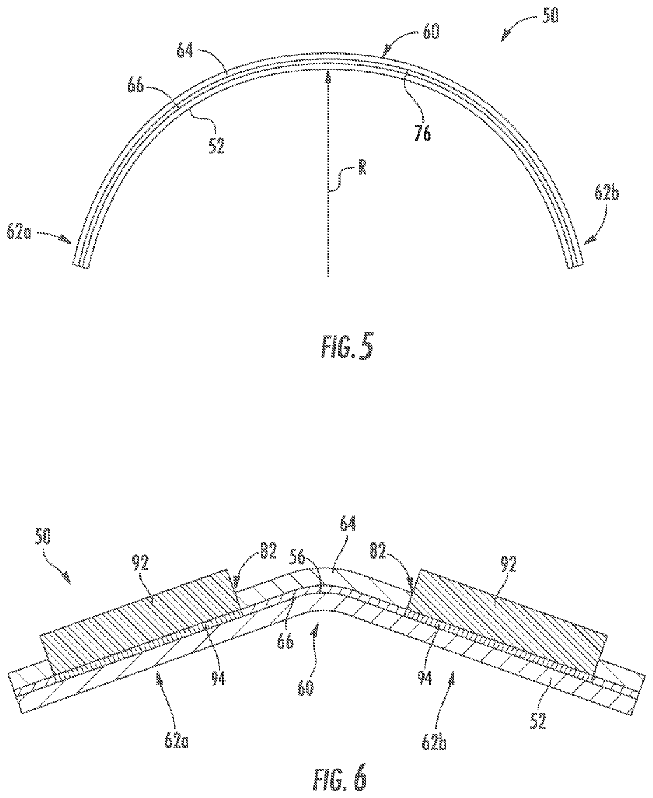

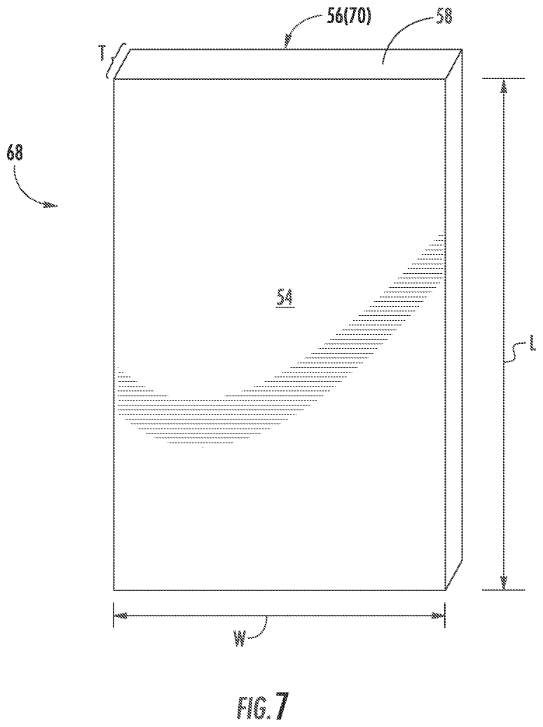

FIG. 6 depicts a cross-section of a vehicle interior component 50 including multiple display units 92 situated in apertures 82 of the frame 64. As can be seen in FIG. 6, the display units 92 are disposed on the second major surface 56 of the glass article 52. In embodiments, the display units 92 are attached to the second major surface 56 of the glass article 52 using an optically clear adhesive 94. In embodiments, the vehicle interior component 50 includes a single display unit 92, and in other embodiments, the vehicle interior component 50 includes two or more display units 92. In one or more embodiments, each display unit 92 is a light emitting diode (LED) display unit, an organic LED (OLED) display unit, a micro-LED display unit, quantum dot display unit (e.g., QLED), liquid crystal display (LCD), or plasma display, among other possibilities. Further, in one or more embodiments, the display unit 92 or display units 92 may be curved, i.e., attached to the glass article 52 in a curved region 60. In embodiments, the display units 92 may be attached to the glass article 52 when the glass article 52 is in the flat configuration, and the display units 92 may be cold-bent with the glass article 52, including bending of the display unit 92, during the cold-forming process described above.

### EXAMPLES

Having described the structure of and method of preparing the vehicle interior component 50, various example embodiments of a frame 64 with a coating 78 are now described in relation to conventional comparative examples. In the first series of comparative examples, the glass articles 52 all included a colorant layer on the second major surface 56, and the frames 64 were anodized aluminum (AA6061) treated with a chemical primer for the adhesive. The frames 64 were joined to the glass article 52 using one of two polyurethane adhesive layers (PUR1 or PUR2). Each of the comparative examples was tested for overlap shear strength (OLS) according to ASTM D1002 and tensile strength (TS) according to ASTM D2095. The overlap shear testing was performed at 1.27 mm/min in shear, and the tensile testing was performed at 1.00 mm/min. Some of the comparative examples were aged before testing by exposure at 85° C. and 95% relative humidity for 500 hours. The comparative examples were then tested at one of three temperatures: −40° C., 23° C., or 95° C. The comparative examples were allowed to cure for one week before testing without aging or allowed to cure for one week before aging and were tested upon completion of aging. The results of the testing are summarized in Tables 1 and 2, below.

TABLE 1
Comparative Examples 1-13 having
Anodized Aluminum Frame (No Aging)

| Comp- | Test | | Average | | | |
|---|---|---|---|---|---|---|
| arative | Temperature | | Strength | Standard | Failure | Test |
| Example | (° C.) | Adhesive | (MPa) | Deviation | Mode | Type |
| 1 | 23 | PUR2 | 4.18 | 0.35 | Mixed | OLS |
| 2 | −40 | PUR2 | 16.06 | 2.98 | Cohesive | OLS |
| 3 | 23 | PUR2 | 5.16 | 0.68 | Cohesive | OLS |
| 4 | 95 | PUR2 | 2.51 | 0.36 | Cohesive | OLS |
| 5 | −40 | PUR1 | 10.79 | 3.88 | Mixed | OLS |
| 6 | 23 | PUR1 | 3.65 | 0.14 | Cohesive | OLS |
| 7 | 95 | PUR1 | 2.34 | 0.21 | Cohesive | OLS |
| 8 | −40 | PUR2 | 9.34 | 1.12 | Mixed | TS |
| 9 | 23 | PUR2 | 3.48 | 0.62 | Mixed | TS |
| 10 | 95 | PUR2 | 2.53 | 0.15 | Cohesive | TS |
| 11 | −40 | PUR1 | 6.73 | 0.29 | Mixed | TS |
| 12 | 23 | PUR2 | 2.66 | 0.78 | Cohesive | TS |
| 13 | 95 | PUR2 | 2.58 | 0.10 | Cohesive | TS |

TABLE 2
Comparative Examples 14-28 having
Anodized Aluminum Frame (Aged)

| Comp- | Test | | Average | | | |
|---|---|---|---|---|---|---|
| arative | Temperature | | Strength | Standard | Failure | Test |
| Example | (° C.) | Adhesive | (MPa) | Deviation | Mode | Type |
| 14 | −40 | PUR2 | 15.84 | 0.62 | Mixed | OLS |
| 15 | 23 | PUR2 | 4.92 | 1.07 | Cohesive | OLS |
| 16 | 95 | PUR2 | 2.38 | 0.24 | Cohesive | OLS |
| 17 | −40 | PUR2 | 15.34 | 1.28 | Cohesive | OLS |
| 18 | 23 | PUR2 | 4.50 | 0.26 | Cohesive | OLS |
| 19 | 95 | PUR2 | 2.39 | 0.32 | Cohesive | OLS |
| 20 | −40 | PUR1 | 8.69 | 1.01 | Mixed | OLS |
| 21 | 23 | PUR1 | 3.84 | 0.17 | Cohesive | OLS |
| 22 | 95 | PUR1 | 1.76 | 0.14 | Cohesive | OLS |
| 23 | −40 | PUR2 | 10.24 | 0.98 | Mixed | TS |
| 24 | 23 | PUR2 | 2.84 | 0.41 | Adhesive | TS |
| 25 | 95 | PUR2 | 1.68 | 0.14 | Cohesive | TS |
| 26 | −40 | PUR1 | 6.34 | 0.28 | Mixed | TS |
| 27 | 23 | PUR1 | 2.90 | 0.24 | Cohesive | TS |
| 28 | 95 | PUR1 | 2.23 | 0.21 | Cohesive | TS |

As can be seen from Tables 1 and 2, the overlap shear strength for the comparative examples using primed surfaces was in the range of 8.69 MPa to 16.06 MPa when tested at −40° C., and the tensile strength was in the range of 6.34 MPa to 10.24 MPa when tested at −40° C. The overlap shear strength for the comparative examples using primed surfaces was in the range of 3.65 MPa to 5.16 MPa when tested at 23° C., and the tensile strength was in the range of 2.66 MPa to 3.48 MPa when tested at 23° C. The overlap shear strength for the comparative examples using primed surfaces was in the range of 1.76 MPa to 2.51 MPa when tested at 95° C., and the tensile strength was in the range of 1.68 MPa to 2.53 MPa when tested at 95° C. Aging did not have a significant effect on the overlap shear strength or the tensile strength for the comparative examples with primed surfaces. Further, the samples mostly failed cohesively (i.e., failure within the adhesive layer), although some exhibited mixed cohesive and adhesive (debonding of the adhesive from the frame or glass article) failure.

In another series of comparative examples, the vehicle interior components 50 were substantially the same as in the first and second sets of comparative examples, with the exception that the frame 64 was a magnesium alloy (AZ31D). Additionally, only one adhesive (PUR1) was used in the comparative examples. The vehicle interior components 50 were tested for overlap shear strength and tensile strength in the same way as described above. The test results are summarized in Tables 3 and 4, below.

TABLE 3
Comparative Examples 29-34 having
Magnesium Alloy Frame (No Aging)

| Comp- | Test | | Average | | | |
|---|---|---|---|---|---|---|
| arative | Temperature | | Strength | Standard | Failure | Test |
| Example | (° C.) | Adhesive | (MPa) | Deviation | Mode | Type |
| 29 | −40 | PUR1 | 4.49 | 1.43 | Primer | OLS |
| 30 | 23 | PUR1 | 2.20 | 0.73 | Mixed | OLS |
| 31 | 95 | PUR1 | 1.14 | 0.57 | Mixed | OLS |
| 32 | −40 | PUR1 | 4.85 | 1.28 | Mixed | TS |
| 33 | 23 | PUR1 | 3.01 | 0.75 | Mixed | TS |
| 34 | 95 | PUR1 | 2.06 | 0.69 | Mixed | TS |

TABLE 4
Comparative Examples 35-40 having
Magnesium Alloy Frame (Aged)

| Comp- | Test | | Average | | | |
|---|---|---|---|---|---|---|
| arative | Temperature | | Strength | Standard | Failure | Test |
| Example | (° C.) | Adhesive | (MPa) | Deviation | Mode | Type |
| 35 | −40 | PUR1 | 0.15 | 0.25 | Primer | OLS |
| 36 | 23 | PUR1 | 0.03 | 0.06 | Primer | OLS |
| 37 | 95 | PUR1 | 0.00 | 0.00 | Primer | OLS |
| 38 | −40 | PUR1 | 0.07 | 0.12 | Primer | TS |
| 39 | 23 | PUR1 | 0.15 | 0.13 | Primer | TS |
| 40 | 95 | PUR1 | 0.03 | 0.07 | Primer | TS |

For the magnesium alloy frames, it can be seen that aging has a significant effect on the overlap shear strength and tensile strength of the primed surfaces. The inventors believe that the significant decrease in overlap shear strength and tensile strength results from the ineffectiveness of the primer at preventing oxidation of the bare metal. The oxidation beneath the primer leads to delamination and a significant reduction in strength.

In still another series of comparative examples, the vehicle interior components 50 were substantially the same as in the preceding comparative examples, with the exception that the frame 64 was anodized aluminum that was provided with an e-coating and treated with a combination of a glass primer and a polyurethane primer. The e-coating was a cationic epoxy e-coating (Powercron® 6000CX, “EP1”). Only one adhesive (PUR2) was used in these comparative examples. The vehicle interior components 50 were tested for overlap shear strength and tensile strength in the same way as described above. The test results are summarized in Tables 5 and 6, below.

TABLE 5
Comparative Examples 41-46 having E-Coated
and Primed Anodized Aluminum Frame (No Aging)

| Comp- | Test | | Average | | | |
|---|---|---|---|---|---|---|
| arative | Temperature | | Strength | Standard | Failure | Test |
| Example | (° C.) | Adhesive | (MPa) | Deviation | Mode | Type |
| 41 | −40 | PUR2 | 14.33 | 2.32 | Adhesive | OLS |
| 42 | 23 | PUR2 | 4.43 | 1.24 | Mixed | OLS |
| 43 | 95 | PUR2 | 2.22 | 0.29 | Cohesive | OLS |
| 44 | −40 | PUR2 | 7.59 | 3.46 | Adhesive | TS |
| 45 | 23 | PUR2 | 3.23 | 0.50 | Adhesive | TS |
| 46 | 95 | PUR2 | 2.66 | 0.19 | Mixed | TS |

TABLE 6
Comparative Examples 47-52 having E-Coated
and Primed Anodized Aluminum Frame (Aged)

| Comp- | Test | | Average | | | |
|---|---|---|---|---|---|---|
| arative | Temperature | | Strength | Standard | Failure | Test |
| Example | (° C.) | Adhesive | (MPa) | Deviation | Mode | Type |
| 47 | −40 | PUR2 | 16.45 | 0.20 | Cohesive | OLS |
| 48 | 23 | PUR2 | 3.95 | 0.71 | Cohesive | OLS |
| 49 | 95 | PUR2 | 2.04 | 0.21 | Cohesive | OLS |
| 50 | −40 | PUR2 | 11.58 | 1.05 | Cohesive | TS |
| 51 | 23 | PUR2 | 3.06 | 0.27 | Adhesive | TS |
| 52 | 95 | PUR2 | 1.76 | 0.14 | Cohesive | TS |

From Tables 5 and 6, it can be seen that the e-coated and primed surfaces of the frame are roughly the same as the primed surfaces, and aging does not have any significant effect on the overlap shear strength and tensile strength of the adhesive joint. However, more of the samples failed adhesively than for the samples where the primer was applied to the anodized aluminum frame.

In a first set of example embodiments, a glass article 52 having a colorant layer 72 was joined to an aluminum (AA6061) frame having one of three cationic epoxy e-coatings 78 (EP1, Powercron® 6200HE (EP2), or Shimin 2630, 2630B (EP3)) using either PUR1 or PUR2. The examples of Table 7 were tested without aging, and the examples of Table 8 were tested after aging (500 hours at 85° C. and 95% relative humidity). Overlap shear testing and tensile testing were carried out as described above.

TABLE 7
Examples 1-20 having E-Coated Aluminum Frame (No Aging)

| | Test | | | | Stan- | | |
|---|---|---|---|---|---|---|---|
| | Temp- | | | Average | dard | | |
| Ex- | erature | Ad- | E- | Strength | De- | Failure | Test |
| ample | (° C.) | hesive | coating | (MPa) | viation | Mode | Type |
| 1 | 23 | PUR2 | EP1 | 4.95 | 1.17 | Cohesive | OLS |
| 2 | −40 | PUR2 | EP1 | 19.84 | 0.96 | Cohesive | OLS |
| 3 | 23 | PUR2 | EP1 | 5.34 | 0.52 | Cohesive | OLS |
| 4 | 95 | PUR2 | EP1 | 2.28 | 0.23 | Cohesive | OLS |
| 5 | −40 | PUR2 | EP2 | 13.95 | 4.58 | Adhesive | OLS |
| 6 | 23 | PUR2 | EP2 | 4.07 | 1.65 | Cohesive | OLS |
| 7 | 95 | PUR2 | EP2 | 1.50 | 0.45 | Adhesive | OLS |
| 8 | −40 | PUR2 | EP1 | 20.71 | 2.50 | Mixed | OLS |
| 9 | −40 | PUR2 | EP1 | 15.59 | 0.54 | Mixed | OLS |
| 10 | 23 | PUR1 | EP3 | 3.93 | 1.41 | Cohesive | OLS |
| 11 | 23 | PUR2 | EP1 | 4.34 | 0.09 | Cohesive | TS |
| 12 | −40 | PUR2 | EP1 | 11.89 | 0.95 | Cohesive | TS |
| 13 | 23 | PUR2 | EP1 | 4.03 | 0.85 | Mixed | TS |
| 14 | 95 | PUR2 | EP1 | 2.35 | 0.12 | Cohesive | TS |
| 15 | −40 | PUR2 | EP2 | 11.95 | 1.38 | Mixed | TS |
| 16 | 23 | PUR2 | EP2 | 3.97 | 0.60 | Adhesive | TS |
| 17 | 95 | PUR2 | EP2 | 2.58 | 0.17 | Mixed | TS |
| 18 | −40 | PUR2 | EP1 | 14.61 | 1.92 | Cohesive | TS |
| 19 | −40 | PUR2 | EP1 | 10.74 | 0.60 | Adhesive | TS |
| 20 | 23 | PUR1 | EP3 | 3.34 | 0.31 | Cohesive | TS |

TABLE 8
Examples 21-44 having E-Coated Aluminum Frame (Aged)

| | Test | | | | Stan- | | |
|---|---|---|---|---|---|---|---|
| | Temp- | | | Average | dard | | |
| Ex- | erature | Ad- | E- | Strength | De- | Failure | Test |
| ample | (° C.) | hesive | coating | (MPa) | viation | Mode | Type |
| 21 | −40 | PUR2 | EP1 | 14.28 | 1.68 | Cohesive | OLS |
| 22 | 23 | PUR2 | EP1 | 3.75 | 0.82 | Cohesive | OLS |
| 23 | 95 | PUR2 | EP1 | 1.94 | 0.20 | Cohesive | OLS |
| 24 | −40 | PUR2 | EP1 | 16.75 | 0.18 | Cohesive | OLS |
| 25 | 23 | PUR2 | EP1 | 4.38 | 0.37 | Cohesive | OLS |
| 26 | 95 | PUR2 | EP1 | 2.51 | 1.29 | Cohesive | OLS |
| 27 | 23 | PUR2 | EP2 | 10.46 | 5.25 | Cohesive | OLS |
| 28 | 23 | PUR2 | EP2 | 2.87 | 1.06 | Adhesive | OLS |
| 29 | 95 | PUR2 | EP2 | 1.82 | 0.28 | Cohesive | OLS |
| 30 | −40 | PUR1 | EP3 | 8.12 | 1.57 | Mixed | OLS |
| 31 | 23 | PUR1 | EP3 | 4.23 | 0.31 | Cohesive | OLS |
| 32 | 95 | PUR1 | EP3 | 2.15 | 0.23 | Cohesive | OLS |
| 33 | −40 | PUR2 | EP1 | 11.52 | 0.78 | Cohesive | TS |
| 34 | 23 | PUR2 | EP1 | 3.46 | 0.17 | Mixed | TS |
| 35 | 95 | PUR2 | EP1 | 1.91 | 0.10 | Cohesive | TS |
| 36 | −40 | PUR2 | EP1 | 9.43 | 1.03 | Cohesive | TS |
| 37 | 23 | PUR2 | EP1 | 2.90 | 0.08 | Mixed | TS |
| 38 | 95 | PUR2 | EP1 | 1.84 | 0.17 | Mixed | TS |
| 39 | −40 | PUR2 | EP2 | 11.83 | 0.58 | Adhesive | TS |
| 40 | 23 | PUR2 | EP2 | 3.67 | 0.24 | Adhesive | TS |
| 41 | 95 | PUR2 | EP2 | 1.94 | 0.09 | Cohesive | TS |
| 42 | −40 | PUR1 | EP3 | 7.09 | 0.11 | Mixed | TS |
| 43 | 23 | PUR1 | EP3 | 3.29 | 0.32 | Cohesive | TS |
| 44 | 95 | PUR1 | EP3 | 1.71 | 0.56 | E-coat | TS |

From Tables 7 and 8, it can be seen that the overlap shear strength and the tensile strength of the example e-coated frames 64 are substantially in line with the conventional primer examples, including the minimal effect of aging on the adhesive joint between the frame 64 and glass article 52. In this way, the e-coating 78 behaves like a primer for the adhesive layer 66 without needing to apply a chemical primer on site. That is, the frames 64 can be fabricated and e-coated at a separate facility designed to apply such coatings, and there is no need to navigate the environmental regulations at the site where the vehicle interior component 50 is assembled. The e-coating 78 has the additional advantage that the entire frame 64 can be encapsulated and thus protected from corrosion. Further, as mentioned above, the e-coating 78 maintains the active surface chemistry needed to create a strong adhesive bond longer than a primed surface. Indeed, most of the samples failed cohesively or mixed cohesive and adhesive failure. A few samples failed adhesively, but the level of strength was on par with a conventional vehicle interior component prepared with the use of chemical adhesive primer.

In a second set of example embodiments, a glass article 52 having a colorant layer 72 was joined to a magnesium alloy (AZ31D) frame having the EP1 cationic epoxy e-coating 78 using PUR1 adhesive layer 66. Table 9 includes both aged and non-aged examples. Overlap shear testing and tensile testing were carried out as described above.

TABLE 9
Examples 45-52 having E-Coated Magnesium Frame

| | Test | | Average | | | |
|---|---|---|---|---|---|---|
| Ex- | Temperature | | Strength | Standard | Failure | Test |
| ample | (° C.) | Aged | (MPa) | Deviation | Mode | Type |
| 45 | −40 | YES | 10.04 | 1.58 | Cohesive | OLS |
| 46 | 23 | NO | 6.36 | 0.46 | Cohesive | OLS |
| 47 | 23 | YES | 4.31 | 0.24 | Cohesive | OLS |
| 48 | 95 | YES | 2.68 | 0.23 | Cohesive | OLS |
| 49 | −40 | YES | 5.56 | 0.69 | Mixed | TS |
| 50 | 23 | NO | 3.48 | 0.82 | Cohesive | TS |
| 51 | 23 | YES | 2.75 | 0.47 | Cohesive | TS |
| 52 | 95 | YES | 2.23 | 0.24 | Mixed | TS |

Table 9 demonstrates that the e-coating 78 works better than primer for magnesium alloy frames 64. As discussed above, the e-coating 78 provides superior protection against corrosion than the primer, which helps prevent the formation of oxidation that leads to delamination.

In one or more embodiments, the overlap shear strength of the adhesive bonded to the e-coating of the frame 64 as measured according to ASTM D1002 is at least 2 MPa, at least 2.5 MPa, or at least 3 MPa when measured at 23° C., and when measured at 23° C. after aging at 85° C. in 95% relative humidity for 500 hours, the overlap shear strength is at least 2 MPa, at least 2.5 MPa, or at least 3 MPa. In one or more embodiments, the overlap shear strength of the adhesive bonded to the e-coating of the frame as measured according to ASTM D1002 is at least 10 MPa, at least 11 MPa, or at least 12 MPa when measured at −40° C., and when measured at −40° C. after aging at 85° C. in 95% relative humidity for 500 hours, the overlap shear strength is at least 8 MPa, at least 9 MPa, or at least 10 MPa. In one or more embodiments, the overlap shear strength of the adhesive bonded to the e-coating of the frame as measured according to ASTM D1002 is at least 2 MPa, at least 2.25 MPa, or at least 2.5 MPa when measured at 95° C., and when measured at 95° C. after aging at 85° C. in 95% relative humidity for 500 hours, the overlap shear strength is at least 1.5 MPa, 1.75 MPa, or at least 2 MPa. Further, in one or more embodiments, the adhesive fails cohesively during testing of the overlap shear strength.

In one or more embodiments, the tensile strength of the adhesive bonded to the e-coating of the frame as measured according to ASTM D2095 is at least 3 MPa, at least 3.5 MPa, or at least 4 MPa when measured at 23° C., and when measured at 23° C. after aging at 85° C. in 95% relative humidity for 500 hours, the tensile strength is at least 2.75 MPa, at least 3 MPa, or at least 3.25 MPa. In one or more embodiments, the tensile strength of the adhesive bonded to the e-coating of the frame as measured according to ASTM D2095 is at least 7 MPa, at least 9 MPa, or at least 11 MPa when measured at −40° C., and when measured at −40° C. after aging at 85° C. in 95% relative humidity for 500 hours, the tensile strength is at least 7 MPa, at least 8 MPa, or at least 9 MPa. In one or more embodiments, the tensile strength of the adhesive bonded to the e-coating of the frame as measured according to ASTM D2095 is at least 1.5 MPa, at least 1.75 MPa, or at least 2 MPa when measured at 95° C., and when measured at 95° C. after aging at 85° C. in 95% relative humidity for 500 hours, the tensile strength is at least 1.5 MPa, at least 1.75 MPa, or at least 2 MPa.

A further set of comparative examples and examples were prepared to determine the effect of a paint coating 78 on a frame 64 made of polyarylamide reinforced with 40% carbon fiber. The comparative examples did not have a painted surface, and half of the comparative examples included a chemical primer applied before the adhesive. Each of examples according to the present disclosure had a paint coating 78 applied to the support surface 76, and for comparison, half of the painted samples also included a chemical primer applied before the adhesive to determine the effect on bonding. The paint coating 78 for eight of the example embodiments was Alexit® Decorating MR 402-MM (PAINT1), and the paint coating 78 for eight other examples was Nextel® Suede Coating 428-22 (PAINT2). For the examples so-indicated, before application of the paint coating 78, a paint primer was applied to the curved support surface 76 of the frame. The paint primer was Alexit® Primer 473-01. The paints and primer are commercially available from Mankewicz in Hamburg, Germany. The samples were tested for overlap shear (OLS) strength and tensile (TS) strength as described above, including without aging and after aging (85° C. in 95% relative humidity for 500 hours). The results of the testing are summarized below in Table 10.

TABLE 10
Plastic Composite Frame with and without Painted Surface

| | Adhesive | | | Strength | Failure |
|---|---|---|---|---|---|
| Paint | Primer | Aged | Test | (MPa) | Mode |
| No | No | No | OLS | 1.09 | Adhesive |
| No | No | Yes | OLS | 1.96 | Mixed |
| No | No | No | TS | 1.5 | Adhesive |
| No | No | Yes | TS | 1.77 | Adhesive |
| No | Yes | No | OLS | 5.29 | Mixed |
| No | Yes | Yes | OLS | 3.87 | Cohesive |
| No | Yes | No | TS | 3.36 | Primer |
| No | Yes | Yes | TS | 3.62 | Cohesive |
| PAINT1 | No | No | OLS | 3.53 | Adhesive |
| PAINT1 | No | Yes | OLS | 2.95 | Adhesive |
| PAINT1 | No | No | TS | 4.31 | Adhesive |
| PAINT1 | No | Yes | TS | 3.27 | Adhesive |
| PAINT1 | Yes | No | OLS | 3.48 | Adhesive |
| PAINT1 | Yes | Yes | OLS | 3.43 | Cohesive |
| PAINT1 | Yes | No | TS | 4.51 | Mixed |
| PAINT1 | Yes | Yes | TS | 3.52 | Cohesive |
| PAINT2 | No | No | OLS | 5.01 | Cohesive |
| PAINT2 | No | Yes | OLS | 3.4 | Cohesive |
| PAINT2 | No | No | TS | 4.22 | Cohesive |
| PAINT2 | No | Yes | TS | 3.19 | Cohesive |
| PAINT2 | Yes | No | OLS | 4.44 | Mixed |
| PAINT2 | Yes | Yes | OLS | 2.9 | Mixed |
| PAINT2 | Yes | No | TS | 3.91 | Mixed |
| PAINT2 | Yes | Yes | TS | 3.47 | Cohesive |

From Table 10, it can be seen that the unpainted samples have significantly lower overlap shear strength and tensile strength absent the chemical primer. That is, for the unpainted samples, the chemical primer is necessary to achieve a requisite level of bonding strength. For the painted samples, it can be seen that primer has substantially no effect on the bonding strength of the adhesive, such that the primer is unnecessary to forming a vehicle interior component of sufficient strength.

In one or more embodiments, the overlap shear strength of the adhesive bonded to the paint on the frame as measured according to ASTM D1002 is at least 3 MPa, at least 3.5 MPa, or at least 3.75 MPa when measured at 23° C., and when measured at 23° C. after aging at 85° C. in 95% relative humidity for 500 hours, the overlap shear strength is at least 2.75 MPa, at least 3 MPa or at least 3.25 MPa. In one or more embodiments, the tensile strength of the adhesive bonded to the paint on the frame as measured according to D2095 is at least 4 MPa when measured at 23° C., and when measured at 23° C. after aging at 85° C. in 95% relative humidity for 500 hours, the tensile strength is at least 3 MPa, at least 3.25 MPa, or at least 3.5 MPa.

Table 11 provides surface properties of the unpainted carbon-reinforced polyarylamide and the frame painted with PAINT1 and PAINT2. In particular, the surface free energy (SFE) was tested using a Kruss DSA100 goniometer. Contact angles of sessile drops (5-6 per condition) were measured using polar fluid (deionized water) and nonpolar fluid (diiodomethane). The OWRK method was used to determine SFE from the contact angles. Additionally, the roughness of the unpainted and painted samples were determined.

TABLE 11
Surface Properties of Painted and Unpainted Frames

| | Unpainted | PAINT1 | PAINT2 |
|---|---|---|---|
| Mean Water Contact | 32.37 | 99.61 | 55.33 |
| Angle (°) | | | |
| Std. Dev. | 7.34 | 5.02 | 4.50 |
| Mean | 61.60 | 82.01 | 16.41 |
| Diiodomethane | | | |
| Contact Angle (°) | | | |
| Std. Dev. | 12.62 | 1.60 | 6.54 |
| Surface Free Energy | 63.22 | 19.01 | 60.53 |
| (mN/m) | | | |
| Std. Dev. | 14.07 | 2.22 | 3.92 |
| Disperse (mN/m) | 27.65 | 16.48 | 48.75 |
| Std. Dev. | 7.26 | 0.80 | 1.61 |
| Polar (mN/m) | 35.57 | 2.54 | 11.78 |
| Std. Dev. | 6.81 | 1.42 | 2.32 |
| RMS roughness | 150.62962 | 59.01563 | 122.55881 |
| (μin) | | | |
| Surface Roughness | 110.78718 | 47.55896 | 95.51162 |
| Rₐ (μin) | | | |

In general, a higher surface free energy is associated with formation of a stronger bond with the adhesive. However, from Tables 10 and 11, it can be seen that, despite having the highest surface free energy, the unpainted frame had the lowest overlap shear strength and tensile strength. Thus, the inventors surmise that the surface chemistry is an important factor in addition to the surface free energy. Nevertheless, in one or embodiments, the water contact angle on the painted surface of the frame is less than 50°. Further, in one or more embodiments, the surface roughness (Rₐ) is less than 100 μm and/or the root mean square (RMS) surface roughness is less than 150 μm.

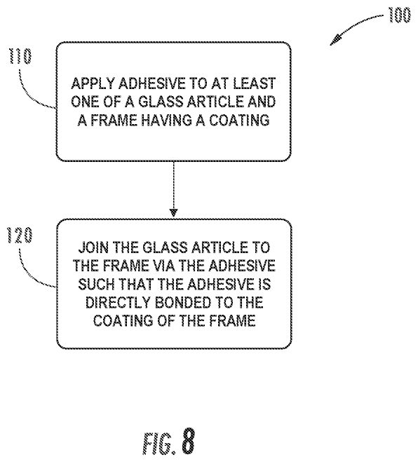

Referring to FIG. 7, additional structural details of a glass substrate 68 of the glass article 52 are shown and described. As noted above, glass substrate 68 has a thickness T that is substantially constant and is defined as a distance between the first major surface 54 and the second major surface 56. In various embodiments, T may refer to an average thickness or a maximum thickness of the glass substrate. In addition, glass substrate 68 includes a width W defined as a first maximum dimension of one of the first or second major surfaces 54, 56 orthogonal to the thickness T, and a length L defined as a second maximum dimension of one of the first or second major surfaces 54, 56 orthogonal to both the thickness and the width. In other embodiments, W and L may be the average width and the average length of glass substrate 68, respectively.

In various embodiments, average or maximum thickness T is in the range of 0.3 mm to 2 mm. In various embodiments, width W is in a range from 5 cm to 250 cm, and length L is in a range from about 5 cm to about 1500 cm. As mentioned above, the radius of curvature at the midpoint (e.g., R as shown in FIGS. 2 and 5) of glass substrate 68 is about 30 mm to about 1000 mm.

In embodiments, the glass substrate 68 may be strengthened. In one or more embodiments, glass substrate 68 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In various embodiments, glass substrate 68 may be strengthened mechanically by utilizing a mismatch of the coefficient of thermal expansion between portions of the article to create a compressive stress region and a central region exhibiting a tensile stress. In some embodiments, the glass substrate may be strengthened thermally by heating the glass to a temperature above the glass transition point and then rapidly quenching.

In various embodiments, glass substrate 68 may be chemically strengthened by ion exchange. In the ion exchange process, ions at or near the surface of the glass substrate are replaced by—or exchanged with—larger ions having the same valence or oxidation state. In those embodiments in which the glass substrate comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass substrate generate a stress.

Ion exchange processes are typically carried out by immersing a glass substrate in a molten salt bath (or two or more molten salt baths) containing the larger ions to be exchanged with the smaller ions in the glass substrate. It should be noted that aqueous salt baths may also be utilized. In addition, the composition of the bath(s) may include more than one type of larger ions (e.g., Na+ and K+) or a single larger ion. It will be appreciated by those skilled in the art that parameters for the ion exchange process, including, but not limited to, bath composition and temperature, immersion time, the number of immersions of the glass substrate in a salt bath (or baths), use of multiple salt baths, additional steps such as annealing, washing, and the like, are generally determined by the composition of the glass substrate (including the structure of the article and any crystalline phases present) and the desired DOC and CS of the glass substrate that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass substrate thickness, bath temperature and glass (or monovalent ion) diffusivity. However, temperatures and immersion times different from those described above may also be used.

In one or more embodiments, the glass substrate 68 may be immersed in a molten salt bath of 100% NaNO₃, 100% KNO₃, or a combination of NaNO₃ and KNO₃ having a temperature from about 370° C. to about 480° C. In some embodiments, the glass substrate may be immersed in a molten mixed salt bath including from about 5% to about 90% KNO₃ and from about 10% to about 95% NaNO₃. In one or more embodiments, the glass substrate may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass substrate may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass substrate. The spike may result in a greater surface CS value. This spike can be achieved by a single bath or multiple baths, with the bath(s) having a single composition or mixed composition, due to the unique properties of the glass compositions used in the glass substrates described herein.

In one or more embodiments, where more than one monovalent ion is exchanged into the glass substrate, the different monovalent ions may exchange to different depths within the glass substrate (and generate different magnitudes stresses within the glass substrate at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass substrate. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from Glasstress Ltd., located in Tallinn Estonia), depending on the strengthening method and conditions. When the glass substrate is chemically strengthened by an ion exchange treatment, FSM or SCALP may be used depending on which ion is exchanged into the glass substrate. Where the stress in the glass substrate is generated by exchanging potassium ions into the glass substrate, FSM is used to measure DOC. Where the stress is generated by exchanging sodium ions into the glass substrate, SCALP is used to measure DOC. Where the stress in the glass substrate is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass substrates is measured by FSM. Central tension or CT is the maximum tensile stress and is measured by SCALP.

In one or more embodiments, the glass substrate may be strengthened to exhibit a DOC that is described as a fraction of the thickness T of the glass substrate (as described herein). For example, in one or more embodiments, the DOC may be in the range of about 0.05 T to about 0.25 T. In some instances, the DOC may be in the range of about 20 μm to about 300 μm. In one or more embodiments, the strengthened glass substrate 68 may have a CS (which may be found at the surface or a depth within the glass substrate) of about 200 MPa or greater, about 500 MPa or greater, or about 1050 MPa or greater. In one or more embodiments, the strengthened glass substrate may have a maximum tensile stress or central tension (CT) in the range of about 20 MPa to about 100 MPa.

Suitable glass compositions for use as glass substrate 68 include soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may include SiO₂ in an amount in a range from about 66 mol % to about 80 mol %. In one or more embodiments, the glass composition includes Al₂O₃ in an amount of about 3 mol % to about 15 mol %. In one or more embodiments, the glass article is described as an aluminosilicate glass article or including an aluminosilicate glass composition. In such embodiments, the glass composition or article formed therefrom includes SiO₂ and Al₂O₃ and is not a soda lime silicate glass.

In one or more embodiments, the glass composition comprises B₂O₃ in an amount in the range of about 0.01 mol % to about 5 mol %. However, in one or more embodiments, the glass composition is substantially free of B₂O₃. As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ in an amount of about 0.01 mol % to 2 mol %. In one or more embodiments, the glass composition is substantially free of P₂O₅.

In one or more embodiments, the glass composition may include a total amount of R₂O (which is the total amount of alkali metal oxide such as Li₂O, Na₂O, K₂O, Rb₂O, and Cs₂O) that is in a range from about 8 mol % to about 20 mol %. In one or more embodiments, the glass composition may be substantially free of Rb₂O, Cs₂O or both Rb₂O and Cs₂O. In one or more embodiments, the R₂O may include the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount in a range from about from about 8 mol % to about 20 mol %. In one or more embodiments, the glass composition includes K₂O in an amount in a range from about 0 mol % to about 4 mol %. In one or more embodiments, the glass composition may be substantially free of K₂O. In one or more embodiments, the glass composition is substantially free of Li₂O. In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may include a total amount of RO (which is the total amount of alkaline earth metal oxide such as CaO, MgO, BaO, ZnO and SrO) in a range from about 0 mol % to about 2 mol %. In one or more embodiments, the glass composition includes CaO in an amount less than about 1 mol %. In one or more embodiments, the glass composition is substantially free of CaO. In some embodiments, the glass composition comprises MgO in an amount from about 0 mol % to about 7 mol %.

In one or more embodiments, the glass composition comprises ZrO₂ in an amount equal to or less than about 0.2 mol %. In one or more embodiments, the glass composition comprises SnO₂ in an amount equal to or less than about 0.2 mol %.

In one or more embodiments, the glass composition may include an oxide that imparts a color or tint to the glass articles. In some embodiments, the glass composition includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

In one or more embodiments, the glass composition includes Fe expressed as Fe₂O₃, wherein Fe is present in an amount up to 1 mol %. Where the glass composition includes TiO₂, TiO₂ may be present in an amount of about 5 mol % or less.

An exemplary glass composition includes SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be included in the amounts otherwise disclosed herein. It should be understood, that while the preceding glass composition paragraphs express approximate ranges, in other embodiments, glass substrate 68 may be made from any glass composition falling with any one of the exact numerical ranges discussed above.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A vehicle interior component, comprising:
a glass article comprising a first major surface and a second major surface, the second major surface being opposite to the first major surface;
a frame comprising a support surface;
a coating disposed on the support surface of the frame;
an adhesive joining the second major surface of the glass article to support surface of the frame;
wherein the adhesive is bonded directly to the coating.

2. The vehicle interior component of claim 1, wherein the frame comprises a metal and wherein the coating is an electrocoating.

3. The vehicle interior component of claim 2, wherein the electrocoating is an acrylic or epoxy coating.

4. The vehicle interior component of claim 2, wherein the support surface is formed of one of a aluminum alloy, a magnesium alloy, or a steel alloy.

5. The vehicle interior component of claim 1, wherein:
the adhesive is a polyurethane, and
an overlap shear strength of the adhesive bonded to the coating satisfies at least one of:
when measured according to ASTM D1002 at 23° C., the overlap shear strength is at least 2 MPa when measured at 23° C.,
when measured according to ASTM D1002, the overlap shear strength is at least 10 MPa when measured at −40° C., and
when measured at −40° C. after aging at 85° C. in 95% relative humidity for 500 hours, the overlap shear strength is at least 8 MPa.

6. The vehicle interior component of claim 1, wherein the adhesive is a polyurethane and wherein a tensile strength of the adhesive bonded to the coating satisfies at least one of:
when measured according to ASTM D2095 at 23° C., the tensile strength is at least 3 MPa,
when measured at 23° C. after aging at 85° C. in 95% relative humidity for 500 hours, the tensile strength is at least 2.75 MPa,
when measured according to ASTM D2095 at −40° C., the tensile strength is at least 7 MPa,
when measured at −40° C. after aging at 85° C. in 95% relative humidity for 500 hours, the tensile strength is at least 7 MPa,
when measured according to ASTM D2095 at 95°, the tensile strength is at least 1.5 MPa, and
when measured at 95° C. after aging at 85° C. in 95% relative humidity for 500 hours, the tensile strength is at least 1.5 MPa.

7. The vehicle interior component of claim 1, wherein the frame comprises a metal, a plastic, or a composite material and wherein the coating is a paint.

8. The vehicle interior component of claim 7, wherein a water contact angle on the coating is less than 50°.

9. The vehicle interior component of claim 7, wherein a surface roughness (Rₐ) of the coating is less than 100 μin, wherein a surface roughness (RMS) of the coating is less than 150 μin.

10. (canceled)

11. The vehicle interior component of claim 7, wherein a paint primer is disposed between the coating and the support surface of the frame.

12. The vehicle interior component of claim 7, wherein the adhesive is a polyurethane and wherein an overlap shear strength of the adhesive bonded to the coating of the frame as measured according to ASTM D1002 is at least 3.5 MPa when measured at 23° C., wherein the overlap shear strength as measured at 23° C. after aging at 85° C. in 95% relative humidity for 500 hours is at least 2.75 MPa.

13. The vehicle interior component of claim 12, wherein a tensile strength of the adhesive bonded to the coating of the frame as measured according to D2095 is at least 4 MPa when measured at 23° C., wherein the tensile strength as measured at 23° C. after aging at 85° C. in 95% relative humidity for 500 hours is at least 3 MPa.

14. The vehicle interior component of claim 1, wherein the second major surface of the glass article comprises an ink coating that has been treated with plasma and wherein the adhesive is bonded directly to the ink coating.

15. (canceled)

16. The vehicle interior component of claim 1, wherein the support surface of the frame defines a curvature having a radius of curvature of 20 mm to 5000 mm and wherein the adhesive joins the second major surface of the glass article to the support surface of the frame such that the glass article conforms to the curvature of the support surface.

17. The vehicle interior component of claim 16, wherein no chemical primer is applied between the adhesive and the coating, wherein no chemical primer is applied between the adhesive and the second major surface of the glass article.

18. (canceled)

19. A frame for a vehicle interior component, comprising:
a support surface defining a curvature and at least one aperture configured to surround a display unit;
a paint coating applied to the support surface;
wherein the curvature has a radius of 20 mm to 5000 mm; and
wherein the paint coating comprises a polyurethane, an acrylic, or an epoxy.

20. The frame of claim 19, wherein the support surface comprises a metal, wherein the metal is an aluminum alloy or a magnesium alloy.

21. The frame of claim 19, wherein the support surface comprises a plastic or composite.

22. The frame of claim 19, wherein a surface roughness (Rₐ) of the paint coating is less than 100 pin, wherein a surface roughness (RMS) of the paint costing is less than 150 min.

23. (canceled)

24. The frame of claim 19, wherein a water contact angle on the paint coating is less than 50°.
